(19) United States
(12) Patent Application Publication
(10) Pub. No.: US 2015/0042049 A1
(43) Pub. Date: Feb. 12, 2015

(54) CHUCK

(71) Applicant: SMW-AUTOBLOK Spannsysteme GmbH, Meckenbeuren (DE)

(72) Inventor: Jürgen Marquart, Markdorf (DE)

(21) Appl. No.: 14/451,991

(22) Filed: Aug. 5, 2014

(30) Foreign Application Priority Data
Aug. 6, 2013 (EP) 13179405.9

(51) Int. Cl. B23B 31/00; B23B 31/16; B23B 31/30

(52) U.S. Cl. CPC B23B 31/001; B23B 31/302; B23B 31/16287; B23B 2231/24
USPC 279/4.12

(57) ABSTRACT

A chuck comprising a chuck body having on one end two guide grooves extending in radial directions, a clamping jaw in each guide groove, a wedge rod drivingly connected with a clamping jaw, the wedge rod being movably mounted in the chuck body, and an actuation piston arranged centrally in the chuck body and in a driving connection with the wedge rods, to provide automatic and independent lubrication of the clamping jaw and the guide groove during each advance movement of the clamping jaws.

A high-pressure pump is disposed in a chuck body chamber, lubricant s in the chamber, a lubricant line in the chuck body extends from the chamber of the high-pressure pump and emerges in a branch from a lubricating line which emerges in a guide groove, and the high-pressure pump is activated by the movement of the wedge rod or wedge hook coupling.

### BACKGROUND OF THE INVENTION

1. Field of the Invention

The invention relates to a chuck, provided on a machine tool for supporting shafts, hollow cylinders, or the like.

2. Description of the Prior Art

A chuck of this kind is disclosed in DE 195 02 363 C1. In this chuck, a hole running in the longitudinal direction of the chuck body is provided in one end of the chuck body and is provided with an actuation piston inserted in it, so as to be axially movable. The actuation piston drives three wedge rods via intermediate elements, the wedge rods being mounted in holding pockets disposed in the chuck body and moveable axially therein. The wedge rods are provided with helical gearing which interacts with one clamping jaw each in a driving connection. Furthermore, three guide grooves running radially are disposed in a free end of the chuck body, and one of the clamping jaws is adapted to be inserted into the guide groove. As soon as the clamping jaw is in a positive-locking active connection with the corresponding wedge rods via its helical gearing, the wedge rods are adapted to be moved via the actuation piston, and the helical gearing between the wedge rods and the underside of the clamping jaw causes the corresponding clamping jaw to be advanced radially in the direction of a workpiece which is to be clamped.

Chucks of this kind have proven effective in practice and are used in a large number of machine tools. When clamped workpieces are machined, contamination arises, for example, due to the cooling lubricants used, or as a result of the metal chips, separated from the workpiece. This contamination in the form of liquid particles, metal chips, and the like is, however, deposited in the guide grooves running in the direction of the workpiece, as a result of which increased friction occurs between the clamping jaw and the guide groove, or the wedge rod, as it advances. However, this causes the clamping force to be reduced, as a result of which reliable securing of the workpiece to be machined is no longer guaranteed. The guide grooves can be manually cleaned to remove the contamination, but this work is time-consuming and thus costly.

This problem has been recognised, and in EP 1 759 793 B1 a chuck is described in which a lubricant supply is provided for each of the three guide grooves. The driving active connection between the clamping jaw and a clamping, or actuation, piston is effected using a wedge hook coupling according to this state-of-the-art.

It is a disadvantage in the operation of the chuck that has been disclosed that the lubricant emerges from the guide grooves due to the centrifugal forces in the direction of pockets in which counterweights are arranged. Pumps built into the pockets are intended to pump the lubricant collected in the pockets in the direction of the guide grooves. In this state-of-the-art, there is no permanent separate lubrication of the guide groove during the advance movement of the clamping jaws.

### SUMMARY OF THE INVENTION

It is the object of the present invention to develop further a chuck of the aforementioned type wherein during each advance movement of the clamping jaws, lubrication of the clamping jaw and guide groove takes place automatically and independently, as a result of which the guide groove and the clamping jaw are also cleaned to remove contamination, thereby limiting the friction between the clamping jaw and the guide groove to a minimum.

As a result of advance movement of the wedge rod or the wedge hook coupling activating a high-pressure pump which contains a specific quantity of lubricant, and because the space in which the high-pressure pump is arranged is filled with lubricant that flows from the high-pressure pump through a lubricating line to a branch, and from there to various positions within the guide groove, the effect is that whenever there is an advance movement of the clamping jaw, the guide groove is filled with lubricant. In this case, the high-pressure pump pumps a precisely specified quantity of lubricant, as a result of which the movement of the clamping jaw along the guide groove distributes the lubricant evenly, so it runs evenly between the clamping jaw and the guide groove, with the effect that the friction between the clamping jaw and the guide groove is reduced and, furthermore, the contamination in the form of cooling lubricants, or metallic chips, is removed.

It is particularly advantageous if a reservoir is additionally worked into the chuck body and is connected via a feed line to the chamber of the high-pressure pump, and if a feed pump is inserted in the reservoir by means of which a particular specified feed pressure is exerted on the lubricant contained in the reservoir, as a result of which the lubricant in the chamber of the high-pressure pump is also under a specified feed pressure. The high-pressure pump exclusively establishes the lubrication pressure required for distributing the lubricant, as a result of which the lubricant is forced into the guide groove.

The reservoir is adapted to be filled from outside with lubricant via a filler line, as a result of which there is a sufficient quantity of lubricant in the reservoir for a particular number of advance movements of the wedge rod, or wedge hook coupling, or clamping jaw. As a result, the lubricant is pressed into the reservoir by means of a grease cartridge containing the lubricant following a particular number of advance movements. The lubricant is held in the reservoir under a pressure of about one to two bar, as a result of which a certain quantity of the lubricant is permanently forced out of the reservoir in the direction of the chamber of the high-pressure pump, causing the chamber of the high-pressure pump to be filled with this amount of lubricant.

The advance movement of the wedge rods, or the distance that the wedge rods have covered for advancing the clamping jaws, depends on the size of the workpiece to be clamped, as a result of which it is advantageous if the actuation rod provided between the wedge rod and the pressure blades of the high-pressure pump consists of two parts mounted one inside the other, in a telescopic arrangement, because as a result the wedge rod can be moved within a particular movement range without the actuation rod being damaged. Rather, the actuation rod can be compressed after reaching a limit position that is defined by the end wall of the chamber in which the high-pressure pump is arranged. As a result of this, the freedom of movement of the wedge rod, and thus the advance travel of the particular clamping jaw, is not limited by the existing arrangement of the high-pressure pump, but, as before, the workpieces can be clamped with their corresponding diameters which were previously held on the chucks of prior art.

### BRIEF DESCRIPTION OF THE DRAWINGS

The drawings show a preferred embodiment of a chuck configured in accordance with the present invention, the details of which are explained below. In the drawings,

FIG. 1a shows a front view of a chuck with a face end in which three guide grooves are disposed, running in a radial direction towards one another, in each of which a clamping jaw is inserted for holding a workpiece to be clamped, and with three wedge rods allocated to the particular clamping jaw, which are in a driving connection with an actuation piston that can be moved axially in the longitudinal direction of the chuck;

FIG. 1b shows a side view of the chuck in accordance with FIG. 1a, with three inlet openings for filling a lubricant into the chuck,

FIG. 2 shows the chuck in accordance with FIG. 1a along section line II-II;

FIG. 3a shows the chuck in accordance with FIG. 1 a along a section line III-III in an initial position;

FIG. 3b shows the chuck in accordance with FIG. 3a in an intermediate position;

FIG. 3c shows the chuck in accordance with FIG. 3a in an end position;

FIG. 4 shows the chuck in accordance with FIG. 1a along a section line IV-IV;

FIG. 5 shows the chuck in accordance with FIG. 1b along a section line V-V; and

FIG. 6 shows the chuck in accordance with FIG. 1a along a section line VI-VI.

### DESCRIPTION OF THE PREFERRED EMBODIMENT

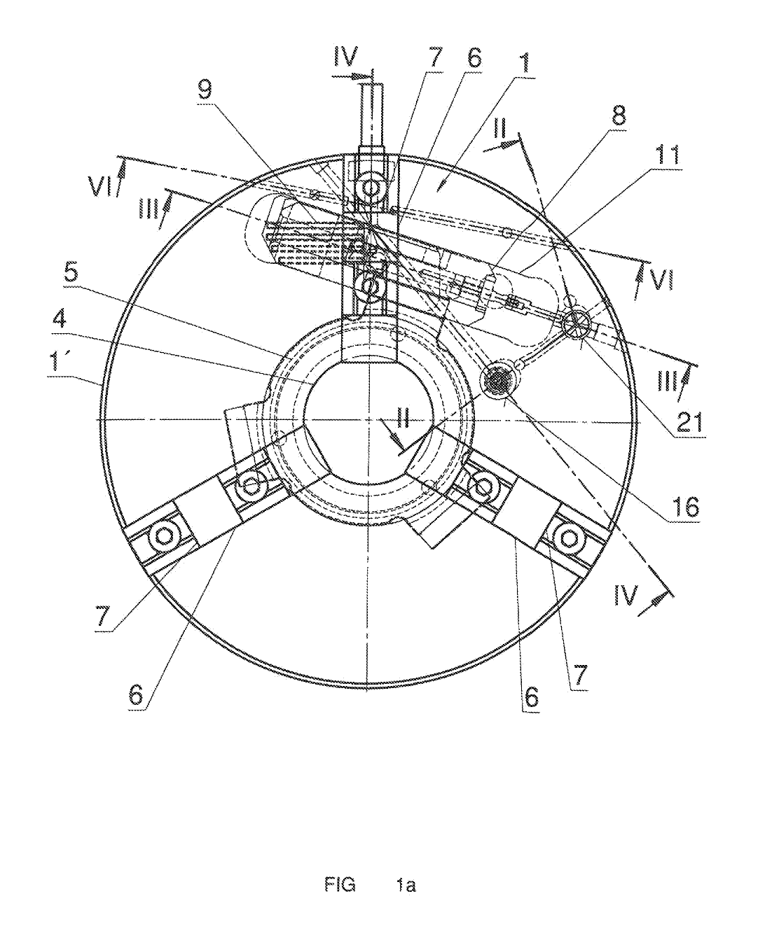

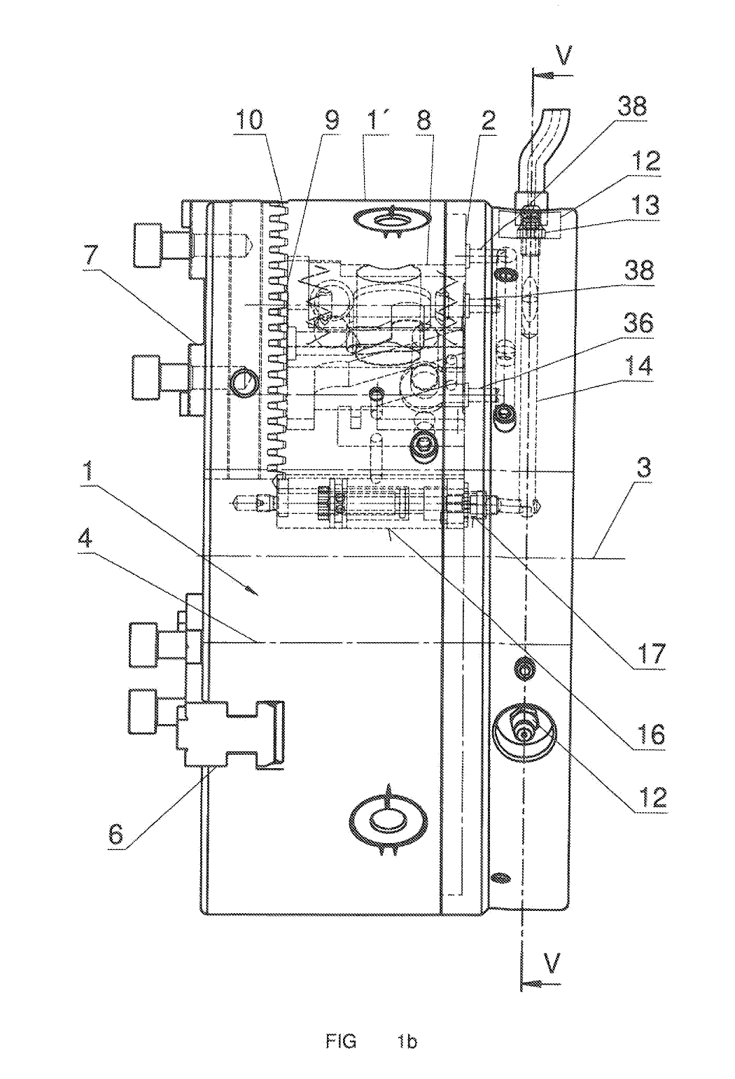

The chuck 1 shown in FIG. 1a comprises a chuck body 1′, having a free end 2, and a longitudinal axis 3. The free end 2 is provided with three clamping jaws 7 pointing in the direction of a workpiece that is not shown, in order to hold he clamping jaws spatially centred on the chuck 1. Such chucks 1 are in particular mounted on machine tools in order to clamp machine shafts, hollow cylinders and other rotationally symmetrical components.

A hole 4 is worked into the chuck body 1′ aligned with the longitudinal axis 3 of the chuck body 1′, and is provided with an actuation piston 5 inserted therein in an axially movable arrangement. The actuation piston 5 can be moved back and forth pneumatically, hydraulically, or electrically, in order to provide both an advance movement and a clamping force of corresponding magnitude to hold workpieces.

Furthermore, the chuck body 1′ is provided with three holding pockets 11 worked into it, with a wedge rod 8 inserted in each in an axially movable arrangement. The wedge rod 8 is in a driven active connection with the actuation piston 5 via intermediate elements, not shown, as a result of which during the axial movement of the actuation piston 5 each of the three wedge rods 8 is moved synchronously back and forth.

Three radial guide grooves 6, running radially in the direction of the hole 4, are worked into the free end 2 of the chuck body 1′, and one of the clamping jaws 7 is adapted to be inserted into each of them. Each of the holding pockets 11 in this case is allocated to one of the guide grooves 6, and the wedge rods 8 pushed into the holding pockets 11 project into the guide grooves 6. As soon as one of the clamping jaws 7 is pushed into the guide grooves 6 from outside, one of helical gearings 9, 10 facing the wedge rod 8 that are worked onto the underside of the corresponding clamping jaw 7 comes into a positive-locking active connection with a helical gearing 9 worked onto the wedge rods 8. As soon as the corresponding wedge rod 8 is moved back and forth by the actuation piston 5, the two helical gearings 9 and 10 cause the clamping jaws 7 to perform a radial advance movements as a result of which they are moved in the direction of the hole 4, meaning that a workpiece can be centrally clamped between the three clamping jaws 7.

Chucks 1 of this kind have proven effective in practice for various sizes of workpieces to be machined, because the adjusting range of the three clamping jaws 7 can be adjusted to differently sized workpiece diameters, meaning that the clamping jaws 7 only have to be changed if a workpiece with significantly different dimensions is to be machined.

Nevertheless, the machining of workpieces causes contamination particles to penetrate the guide grooves 6. Such contamination particles can be caused, for example, by cooling or lubricating fluids, or else by the metallic chips that are cut off during machining of the workpiece. As soon as such contamination particles are deposited in the guide grooves 6, however, these particles get in between the corresponding clamping jaws 7 when they are subsequently moved, as a result of which the coefficient of friction between the pairing of the clamping jaw 7 and guide groove 6 is significantly increased. Such an increase in friction means that the actuation force to be transferred onto the workpiece by the clamping jaws 7 is reduced because the friction forces between the clamping jaws 7 and the guide groove 6 are opposed by the clamping force. Furthermore, the advance accuracy, and/or precision, of clamping are impaired by the contamination particles, because the synchronous movements of the clamping jaws 7 can be disrupted by the contamination particles.

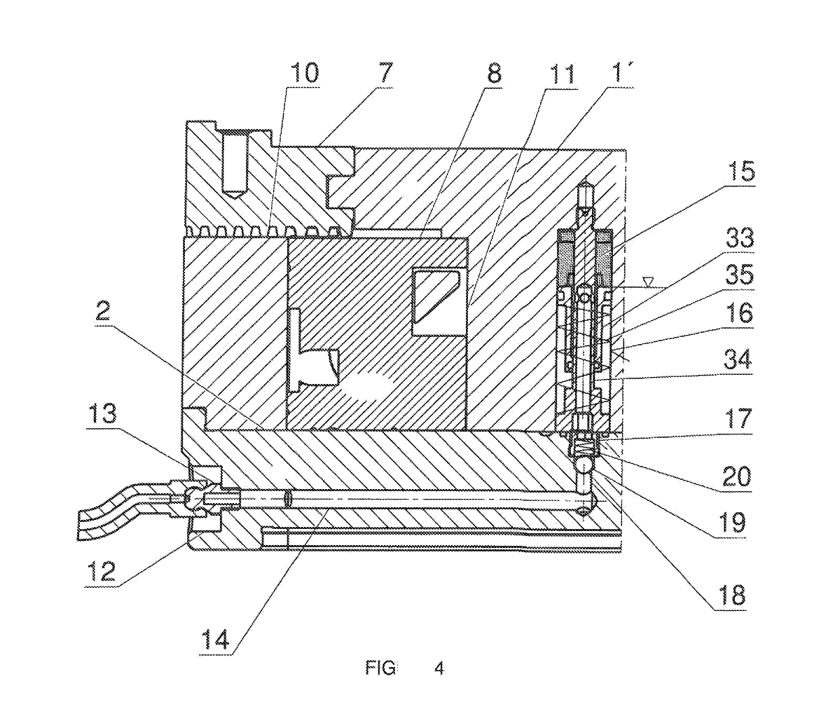

The chuck 1 according to the present invention is intended to clean this contamination between the clamping jaw 7 and the guide groove 6 during each advance movement of the wedge rod 8, as a result of which the coefficient of friction between the guide groove 6 and the clamping jaw 7 is kept as low as possible. One way in which this purpose is accomplished is that three filler openings 12, as shown in FIG. 1b, are worked into the chuck body 1′ and are closed by a plug 13 in operational status. The plugs 13 can be released from the filler openings 12 when the chuck 1 is stationary, in order to be filled with lubricant 39 by means of a grease cartridge, for example, which contains the lubricant 39. The pressure at which the grease cartridge injects the lubricant 39 means that it enters a reservoir 15 worked into the chuck body 1′, as is shown in FIG. 4 in particular. In this case, the filler opening 12 is connected to the reservoir 15 via a feed line 14.

Between the reservoir 15 and the feed line 14, there is a non-return valve 17 installed, comprising a ball 18, a valve seat 19 and a coil compression spring 20. The pressure at which the lubricant 39 is injected forces the ball 18 out of the valve seat 19, and the lubricant 39 enters the reservoir 15. As soon as the injection pressure is no longer present, the ball 18 is pressed into the valve seat 19 by the coil compression spring 20, meaning that the reservoir 15 is closed.

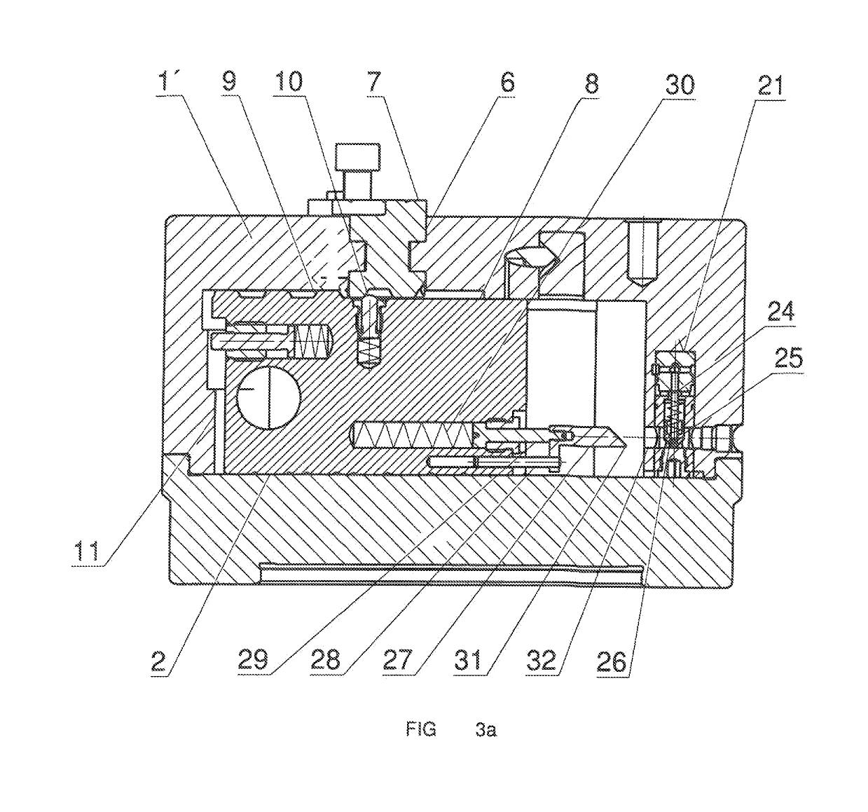

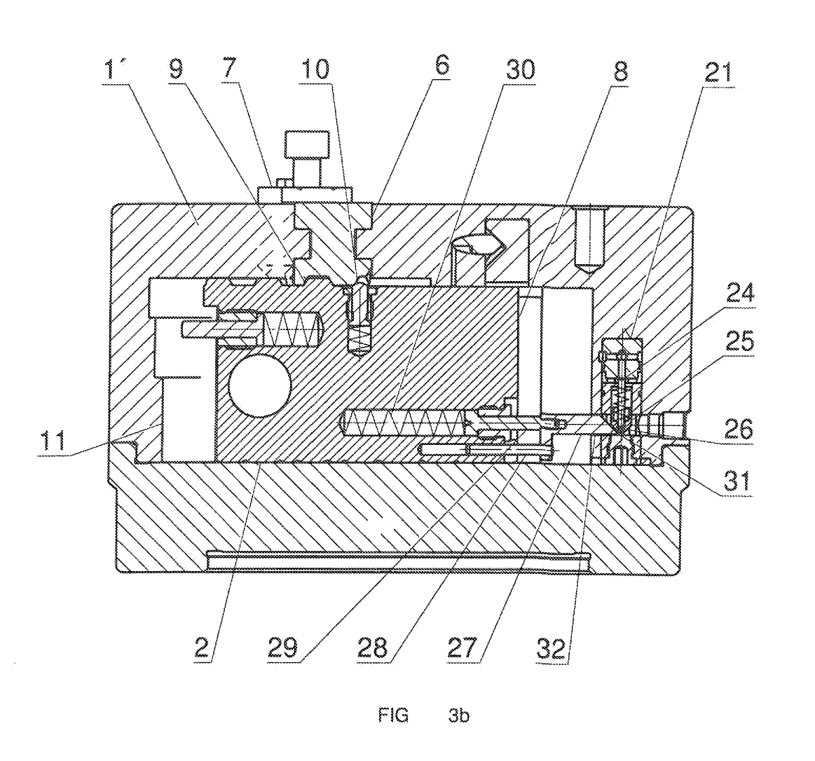

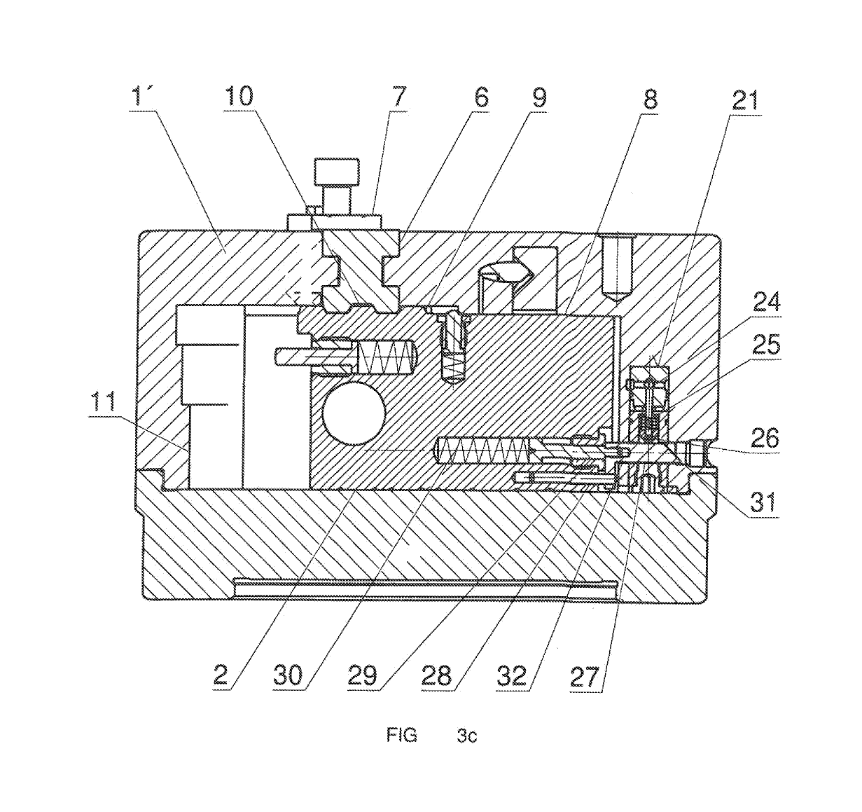

The reservoir 15 contains a feed pump 16 by means of which a particular quantity of lubricant 39 is injected from the reservoir 15 through a feed line 23 into a chamber 22. The chamber 22 contains a high-pressure pump 21 by means of which the lubricant 39 reaches a branch 27 through a lubricant line 36 when the wedge rod 8 is activated, as shown in FIGS. 3a, 3b, 3c. As is explained further below, there are three distribution lines 28 provided at the branch 27, each of which emerges at a different position in the guide groove 6, with the effect that the high-pressure pump 21 prompts the lubricant 39 to three different positions in the guide groove 6.

The feed pump 16 consists of a bearing pin 34 with a blind hole worked into it as a reservoir 15. A piston 33 and coil compression spring 35 consequently exert a constant feed pressure on the lubricant 39, which is about one to two bar, with the effect that the lubricant 39 is forced out of the reservoir 15 through the feed line 23 into the chamber 22 of the high-pressure pump 21. The volume of lubricant 39 output depends on the size of the reservoir 15 which is divided into two sub-areas by the piston 33, such that the first sub-area of the reservoir 15 is to be regarded as a reservoir chamber and the second sub-area of the reservoir 15 has an output chamber. The feed line 23 emerges in the sub-area of the reservoir 15 that functions as the output chamber.

FIG. 3a shows the driving active connection between the wedge rod 8 and the high-pressure pump 21. The high-pressure pump 21 consists of a bearing pin 24 with a pressure plate 25 attached to it in an axially movable arrangement. An actuation pin 27′ is installed in the wedge rod 8 and comprises first and second sub-sections 28′ and 29 which are supported on the wedge rod 8 via a coil compression spring 30, and slide one inside the other in a telescopic arrangement if needed.

The pressure plate 25 is provided with a slanted plane 26 aligned in the direction of the actuation pin 27′, and a tip 31 of the actuation pin 27′ is aligned in the opposite direction to the slanted plane 26 of the pressure plate 25.

FIG. 3b shows that the tip 31 of the actuation pin 27′ acts on the slanted plane 26 of the pressure plate 25 as soon as the wedge rod 8 is advanced in the direction of the chamber 22. The movement of the wedge rod 8 results in the radial advance movement of the corresponding clamping jaw 7. As this advance movement of the wedge rod 8 continues, initially the coil compression spring 30 is compressed between the wedge rod 8 and the actuation pin 27′, while at the same time the pressure plate 25 is moved axially along the bearing pin 24, as a result of which the lubricant 39 contained in the chamber 22 is forced out of it and injected into the lubricant line 36 at a pressure of about 200 bar.

FIG. 3c shows that the advance movement of the wedge rod 8 is not obstructed by the arrangement of the high-pressure pump 21 in the chamber 22, because the actuation pin 27′ can be moved further at a lateral offset from the pressure plate 25, and the tip 31 of the actuation pin 27′ is pushed into an accommodation hole 32. Also, the telescopic configuration of the actuation pin 27′ involving the first and second sub-sections 28′ and 29 allows the length of the actuation pin 27′ to be reduced, so that the movement of the wedge rod 8 is not obstructed by the high-pressure pump 21. Furthermore, the high-pressure pump 21 always completes a lifting movement of equal magnitude, meaning that precisely the quantity of lubricant 39 contained in the chamber 22 is forced out of it.

As soon as the wedge rod 8 has been moved back to the initial position shown in FIG. 3a, the pressure plate 25 is moved back to the initial position because the pressure plate 25 is acted on with a corresponding return force via the coil compression spring 30. The feed pump 16 fills an equally sized amount of lubricant 39 from the reservoir 15 into the chamber 22 of the high-pressure pump 21, meaning that the high-pressure pump 21 can once again pump a sufficient amount of lubricant 39.

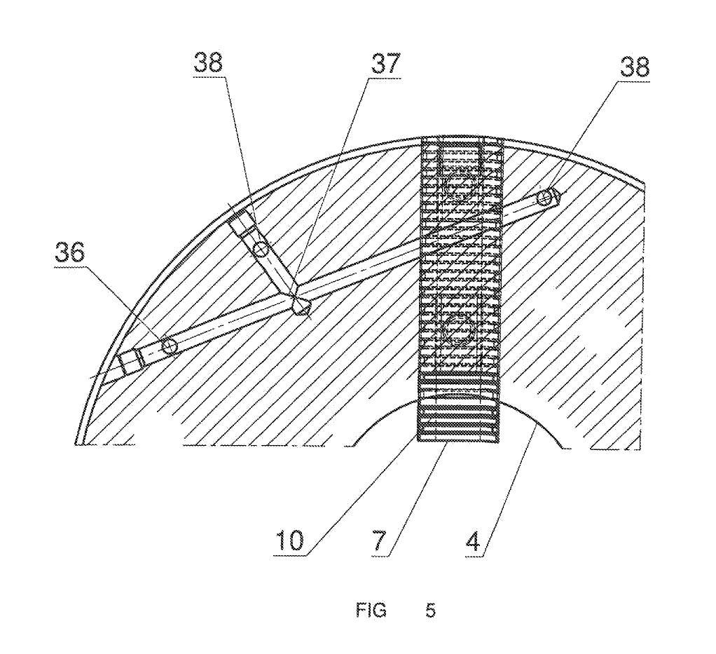

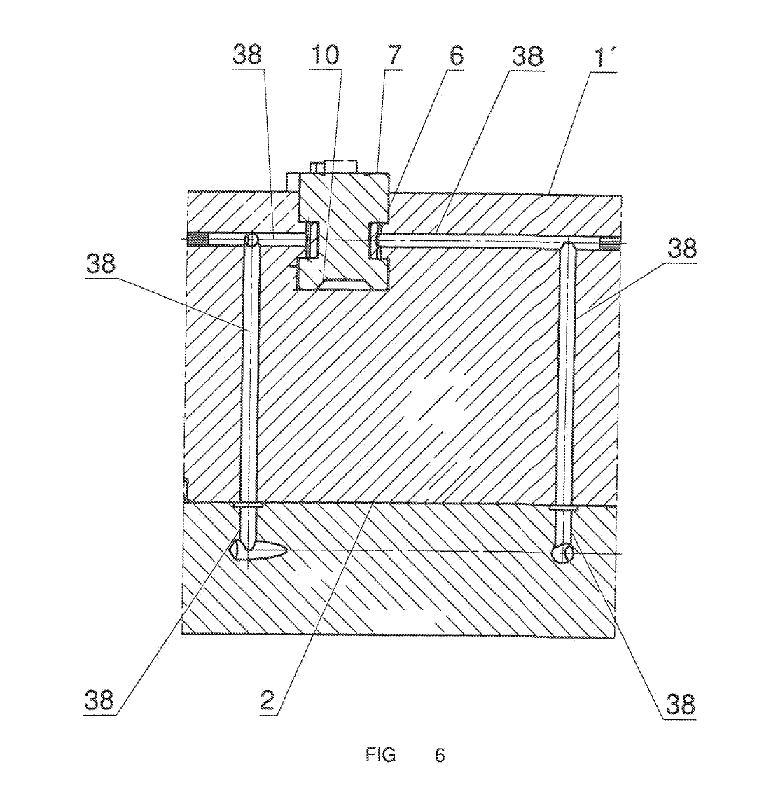

FIGS. 5 and 6 show how the lubricant from chamber 22 enters the guide groove 6. In this case, two distribution lines 38 start from a branch 37 and the lubricant 39 can flow into them. The distribution lines 38 each end in a different position in the guide groove 6.

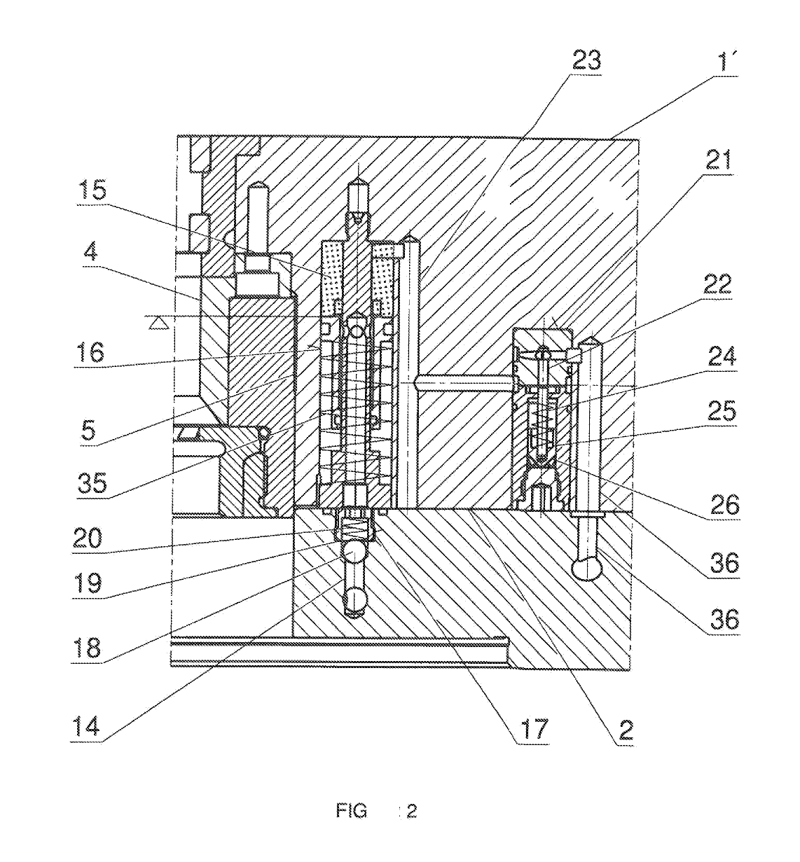

Also, each guide groove 6 has a pumping device for lubricant 39 allocated to it, as explained in FIGS. 1a to 6.

Furthermore, it is a straightforward procedure for the specialist to replace the described driven active connection between the clamping jaw 7 and the wedge rod 8 with a wedge hook coupling, as dealt with in the introduction to the description, and to activate the high-pressure pump 21 via the advance movement of the wedge hook coupling.

1. A chuck comprising a chuck body having disposed on one end at least two guide grooves running in a radial direction, a clamping jaw inserted into each of the guide grooves, a wedge rod allocated to each clamping jaw, and in a driven connection therewith via helical gearing, wherein the wedge rod is mounted in the chuck body in a selected one of a movable arrangement, and a wedge hook coupling, and an actuation piston arranged centrally in the chuck body and in a driving active connection with the wedge rods or the wedge hook coupling,
wherein
a high-pressure pump is arranged in a chamber provided in the chuck body, a lubricant is filled in the chamber, a lubricant line in the chuck body extends from the chamber of the high-pressure pump and to a branch from which at least one lubricating line branches off, each lubricating line emerging in a different position in the guide grooves, and the high-pressure pump is adapted to be activated by advance movement of the corresponding wedge rod or wedge hook coupling.

2. The chuck in accordance with claim 1,
wherein
a plurality of line sections are embedded in the chuck body, and a feed line extends from the outside the chuck body to a reservoir in the chuck body for accommodating the lubricant, and a feed line extending from the reservoir is disposed in the chuck body and emerges in the chamber of the high-pressure pump.

3. The chuck in accordance with claim 2,
wherein
a feed pump adapted to which establish a feed pressure is provided in the reservoir.

4. The chuck in accordance with claim 1,
wherein
the high-pressure pump comprises a pressure plate attached to a bearing pin and mounted in the chamber so as to be movable along the bearing pin, a coil compression spring is provided between said pressure plate and a housing wall featuring a ring-shaped stop, and a slanted plane pointing in the direction of said wedge rod is disposed on said pressure plate, wherein the slanted plane is moved in the direction of the stop by means of an actuation pin attached to said wedge rod, or a wedge hook coupling.

5. The chuck in accordance with claim 3,
wherein
the feed pump in the reservoir comprises an axially movable stroke piston in the reservoir adapted to be moved against the force of a coil compression spring, the reservoir is disposed in the stroke piston which is sealed in the area of the inlet opening of the filler hole by means of a non-return valve, and in the area of the end of a filler hole, the line section emerges between the reservoir and the chamber of the high-pressure pump.
